(19) United States
(12) Patent Application Publication
(10) Pub. No.: US 2006/0280174 A1
(43) Pub. Date: Dec. 14, 2006

(54) Method and system for establishing a data link layer protocol on a physical layer port connection

(75) Inventor: Rasmus Villefrance, Helsinge (DK)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 10/571,290

(22) PCT Filed: Sep. 10, 2003
(86) PCT No.: PCT/IB03/03868

§ 371 Date: Mar. 9, 2006

(51) Int. Cl. H04L 12/56; H04J 3/16

(52) U.S. Cl. 370/389; 370/469

(57) ABSTRACT

This invention relates to a method for establishing a data link layer connection enabling data communication between modules connected through a port connector. The modules may be a mobile communication device such as a cell or mobile telephone, and a peripheral such as a functional cover, a camera or the like. In addition, this invention relates to a data package configured according to a data link layer protocol.

### FIELD OF INVENTION

This invention relates to a method for establishing a data link layer connection enabling data communication between modules in a system connected through a port connection, such as a Universal Asynchronous Receiver-Transmitter (UART) port connection. The modules may be a mobile communication device such as a cell or mobile telephone, and a wired peripheral. In addition, this invention relates to a data package for transmitting through a port connector and configured according to a data link layer protocol.

### BACKGROUND OF INVENTION

As described in American patent application entitled “Method and system establishing a data link layer protocol on a I²C physical layer connection” by this applicant, which patent application is hereby incorporated by reference, the I²C-bus specification published by Philips Semiconductors is a de facto world standard for providing the physical layer for data communication between a plurality of connected integrated circuits (ICs).

Similarly, communication between modules through a UART port connection must comply with a specification, which may be open or proprietary. Generally, mobile or cell telephones communicate through a UART port, such as a communication port as in Nokia 3510, with a peripheral by utilising a proprietary protocol. This approach is not satisfactory since some modules have operating systems, which do not support a particular protocol, thus these modules become incompatible with other modules having different operating systems supporting the particular protocol. For example, connecting a Nokia mobile telephone having an operating system, such as Intelligent Software Architecture (ISA), to an enhancement module having an operating system, such as Symbian not supporting a particular protocol, through a communication port leads to incompatibility between the mobile telephone and the enhancement module.

Hence, whenever data is to be transferred through a port connection there is a need for establishing compatibility between old and new modules, or modules using different transport layer protocols. That is, when a new module is to be connected with an existing system utilising the port connection operating in accordance with a first set of data exchange rules the new module is required to communicate in accordance with the first set of data exchange rules when communicating with the existing module. Thus a series of sets of data exchange rules are required or, alternatively, the oldest set of data exchange rules determines which rules should be used, thereby severely limiting further developments.

### SUMMARY OF THE INVENTION

An object of the present invention is to provide a method and system for solving the above mentioned problems and shortcomings of the prior art, and to provide a data link layer protocol providing backward and forward compatibility in a system of connecting modules through a port connection.

Further, the object of the present invention is to provide a data link layer protocol enabling data communication between modules using a wide variety of transport layer protocols and connected through a port connection.

A particular advantage of the present invention is provision of a data package within the data frame, which data package may carry any kind of transport data through the port connection.

A particular feature of the present invention relates to the fact that the data link layer protocol does not require any particular running “mode”, such as RS232 modes, on the port connection.

The above objects, advantage and feature together with numerous other objects, advantages and features, which will become evident from below detailed description, are obtained according to a first aspect of the present invention by a system for providing data communication between modules connected through a port connection, wherein said modules are adapted to communicate a data package comprising in a layered structure a physical layer comprising a first and a second segment for encapsulating other layers in said data package, a data link layer comprising a first header field for data payload type and a second header field for a data link layer version, and a network/transport layer comprising a third header field for a transmitting module's address, a fourth header field for a length of said data package, and comprising data payload.

A further feature of the present invention relates to the fact that the data link layer protocol is compatible with data link layer protocol for I²C-connected peripherals. This fact yields an improved flexibility during development of a peripheral since the definition of the physical layer may be postponed to a rather late phase of the development.

By adding further layers onto the physical layer data frame for a port connection, such as a UART port connection, significant advances may be accomplished. By packaging the payload to be transferred through the port connection with an additional header section containing data for further layers in a reference model a structured approach is achieved, in which a data package may comprise data configured according to a wide variety of payload types (according to protocols) which may be appropriately identified by the receiving module. That is, the system enables various modules utilising a plurality of protocols to be connected to the port connection thereby enabling forward and backward compatibility.

The term “communicate” is in this context to be construed as receiving or transmitting a data package in any configuration, for example a master/slave configuration.

Further, the terms “first”, “second” and so on are in this context to be construed as identifying numbers and not as a physical position on a time line per se. Nevertheless, the term should be construed to encompass a position on a time line.

In addition, the term data package is in this context to be construed as a datagram or a data packet, i.e. a package to be communicated through a port connection, which package generally comprises a header section and a payload section together with a termination or tailing section. The information contained in the header section may be interpreted as a series of layers, where the term “layered structure” in this context is to be construed as a reference model such as open systems interconnection (OSI), where the main idea is that the process of communication between two end points in a network can be divided into layers, with each layer adding its own set of special, related functions.

The modules according to the first aspect of the present invention may comprise a mobile communication device, such as a cell, mobile or satellite telephone, a personal digital assistant, or peripherals thereto. The term “module”, however, is in this context to be construed broadly as an electronic enhancement element, such as for example a functional cover.

The data payload type according to the first aspect of the present invention may comprise OBEX (device independent communication protocol that allows data to be shared between devices), PhoNet (Nokia proprietary protocol), TCP (Transmission control protocol), IP (Internet protocol), HTTP (Hypertext transfer protocol), or any proprietary payload type. In fact, the system is, as mentioned above, backward as well as forward compatible and therefore further future types of payload types (protocols) may be incorporated in the system.

The data link layer version according to the first aspect of the present invention may comprise a major version, which is binary incompatible, and a minor version, which is binary compatible.

The data package according to the first aspect of the present invention may further comprise in said network/transport layer a fifth header field for an offset value for determination of data payload start in said data package. The offset value provides means for compensating for future changes to the network/transport protocols, since the receiving module through the offset value may jump directly to the payload start when the receiving module does not require the potential data from header.

The data package according to the first aspect of the present invention may further comprise in said network/transport layer a sixth header field prior to said data payload start in said data package for buffering. The sixth header field in the network/transport layer is particularly advantageous when the future extension of the header is to be incorporated. The offset value compensates for the potentially shifted start of the data payload.

The data package according to the first aspect of the present invention may further comprise a checksum field following the data payload. The checksum provides means for a processor to calculate whether the received data payload has been received correctly.

The data package according to the first aspect of the present invention may further comprise in said network/transport layer a seventh header field for a data package number and may further comprise in said network/transport layer an eighth header field for a data package fragment sequence number. The data package number provides means for splitting data messages in a plurality of data packages, and the data package fragment sequence number provides means for rejoining the split data messages into a particular order.

The first segment of the physical layer according to the first aspect of the present invention may comprise a media field for defining media, across which the data package is transferred, such as a UART port connection. The first segment may further comprise a synchronization field for synchronizing the receiving module with the transmitting module. The synchronization field may comprise a value of 55h (hexadecimal). The first segment defines a first part of the data frame of the data package, during which the receiving module establishes the required receiving state of the receiving module. The media field may define a plurality of connection types known to the person skilled in the art.

The second segment of the physical layer according to the first aspect of the present invention may comprise an index byte for providing the receiving module with information regarding segmentation or partitioning of data contained in a message. This is particularly advantageous when the data package to be transmitted is longer than allowed by the port connector or the receiving module.

The second segment according to the first aspect of the present invention may further comprise a sequence and acknowledge field for providing the receiving module with information whether the data package is an acknowledgement message or an ordinary message. Alternatively, if the data package is an acknowledgement message the sequence and acknowledge byte is adapted to provide to inform whether an error was identified in the received data package.

The sequence and acknowledgement field according to the first aspect of the present invention may further be adapted to inform the receiving module that a sequence number in the receiving module should be reset. In addition, the sequence and acknowledgement field may be adapted to recognise acknowledgement messages and detect missing data packages.

The second segment according to the first aspect of the present invention may further comprise a fill field for ensuring that all data packages sent over the port connector contain an even amount of bytes. The fill field makes sure that the communication between modules is consistent thus ensuring a high level of throughput.

The second segment according to the first aspect of the present invention may further comprise a parity field for storing parity calculated on the basis of the data package excluding the parity field. The parity field ensures that the receiving module has a continuous possibility of comparing validity of the contents of the data packages.

The above objects, advantages and features together with numerous other objects, advantages and features, which will become evident from below detailed description, are obtained according to a second aspect of the present invention by a data package for communicating between modules connected through a port connection, wherein said data package comprising in a layered structure physical layer data a first and a second segment for encapsulating other layers in said data package, data link layer data in a first header field comprising data payload type and in a second header field comprising a data link layer version, and network/transport layer data in a third header field comprising a transmitting module's address, in a fourth header field comprising a length of said data package, and comprising data payload.

The data package according to the second aspect of the present invention may incorporate any features of the system according to the first aspect of the present invention.

The above objects, advantages and features together with numerous other objects, advantages and features, which will become evident from below detailed description, are obtained according to a third aspect of the present invention by a receiver unit adapted to receive a data package according to the second aspect of the present invention.

The above objects, advantages and features together with numerous other objects, advantages and features, which will become evident from below detailed description, are obtained according to a fourth aspect of the present invention by a transmitter unit adapted to transmit a data package according to second the aspect of the present invention.

The above objects, advantages and features together with numerous other objects, advantages and features, which will become evident from below detailed description, are obtained according to a fifth aspect of the present invention by a method for establishing data communication between modules connected through a port connection, wherein said modules communicate a data package comprising in a layered structure a physical layer comprising a first and a second segment for encapsulating other layers in said data package, and wherein said method comprising: providing in said data package in a data link layer a first header field for data payload type and a second header field for a data link layer version, providing in said data package in a network/transport layer a third header field for a transmitting module's address and a fourth header field for a length of said data package, and providing in said data package a data payload.

The method according to the fifth aspect of the present invention may incorporate any features of the system according to the first aspect of the present invention, any features of the data package according to the second aspect of the present invention, any features of the receiver unit according to the third aspect of the present invention, and any features of the transmitter unit according to the fourth aspect of the present invention.

The above objects, advantages and features together with numerous other objects, advantages and features, which will become evident from below detailed description, are obtained according to a sixth aspect of the present invention by a computer program comprising code adapted to perform the following steps when said program is run in a data processor adapted to establish data communication between modules connected through a port connection, wherein said modules communicate a data package comprising in a layered structure having a physical layer comprising a first and a second segment for encapsulating other layers in said data package, and wherein said program providing in said data package in a data link layer a first header field for data payload type and a second header field for a data link layer version, providing in said data package in a network/transport layer a third header field for a transmitting module's address and a fourth header field for a length of said data package, and providing in said data package a data payload.

The computer program according to the sixth aspect of the present invention may incorporate any features of the system according to the first aspect of the present invention, any features of the data package according to the second aspect of the present invention, and any features of the method according to the third aspect of the present invention.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawing, wherein:

FIG. 1a, shows a physical layer (data frame) and data of a data package to be transferred through a port connection according to the preferred embodiment of the present invention,

FIG. 1b, shows the preferred embodiment of a data package according to the present invention,

FIG. 2, shows data link layer establishing communication for a functional cover and a mobile communication device,

FIG. 3, shows an application layer communication, first connection establishment, then two examples of communication,

FIG. 4, shows how the functional cover checks which midlets are installed on the mobile communication device,

FIG. 5, shows transmission of a midlet from the functional cover to a mobile communication device,

FIG. 6, shows how the functional cover starts a midlet without any user interaction, and

FIG. 7, shows how a user starts a midlet from an application menu.

### DETAILED DESCRIPTION OF PREFERRED EMBODIMENTS

In the following description of the various embodiments, reference is made to the accompanying figures, which form a part hereof, and in which by way of illustration various embodiments are shown, in which the invention may be practiced. It is to be understood that other embodiments may be utilized and structural and functional modifications may be made without departing from the scope of the present invention.

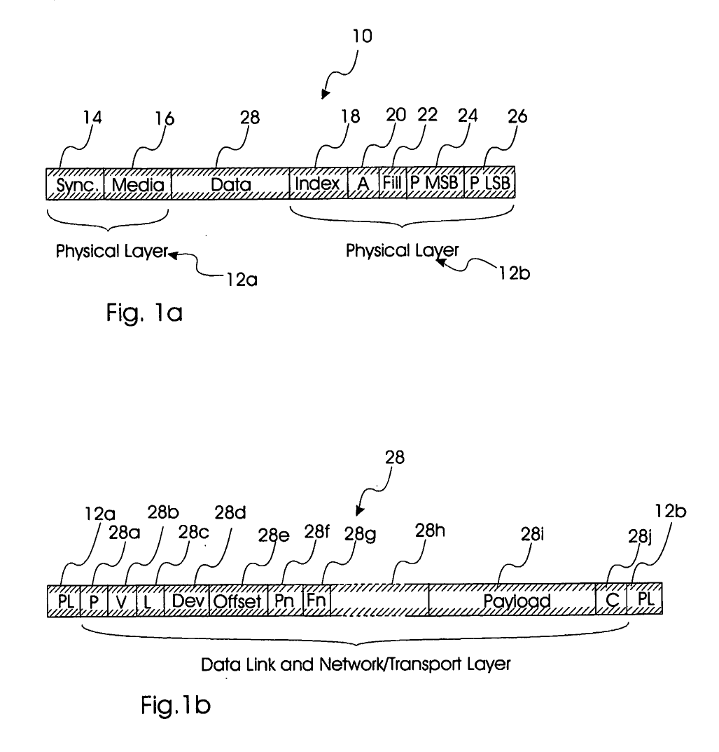

FIG. 1a shows a data package 10 comprising a physical layer or data frame 12a, 12b encapsulating data to be communicated through a port connection according to the preferred embodiment of the present invention. The data frame 12a, 12b comprises a first segment 12a before the data segment and a second segment 12b tailing the data segment.

The first segment 12a comprises synchronization bytes 14 for synchronizing the modules connected through the port connection. The synchronization bytes 14 comprises 8 bytes containing 55h (hexadecimal corresponding to a series of “0” and “1”). Following the synchronization bytes 14 the transmitting module enters a wait state for 20 ms thereby allowing the receiving module to synchronize. It should be noted that the synchronization bytes 14 may by defined as a preliminary state of a transmission state not part of the physical layer of a data package.

Following the synchronization bytes 14 the first segment 12a of the physical layer comprises a media byte 16, which is used to describe the physical media, across which the data package is transferred. The media byte 16, further in some instances as described below, describes which type of data is encapsulated in the data segment by the physical layer.

The second segment 12b comprises an index byte 18 providing the receiving module with information regarding segmentation or partitioning of data contained in a message. That is, when a message is larger than allowed for by the data package size.

The index byte 18 may comprise values from 1 to 255, and in case of no segmentation of the message the value is 1. In case, the message is divided into 3 segments the first index byte 18 of the first data package comprising a first part of the segmented message has a value of 3, the second data package comprising a second part of the segmented message has a value of 2, and lastly the final data package comprising a final part of the segmented message has a value of 1.

The second segment 12b further comprises a sequence and acknowledge byte 20, which has several purposes. The first bit (the most significant bit (MSB)) provides information whether the data package is an acknowledgement message or an ordinary message. If the first bit is “1”, then it is not necessary to send an acknowledgement message back. Generally, external modules, such as mobile telephone enhancement device, request acknowledgement messages to be returned and therefore the first bit in these instances is “0”. In a returned acknowledgement message the first bit is used to inform whether an error was identified in the received data package.

The second bit in the acknowledgement byte 20 when set to “1” is a further indication of a first data package of a plurality of data packages defining a message.

The third bit in the acknowledgement byte 20 when set to “1” informs the receiving module that the receiving module's RX sequence number should be reset. The third bit is normally set to “1” in the first data package received by the module and “0” in all subsequent data packages.

The fourth and fifth bit in the acknowledgement byte 20 are at present set to “0”.

The three least significant bits namely sixth, seventh and eighth bit in the acknowledgement byte 20 is used for recognizing acknowledgement messages and for detecting missing data packages. Every module has to maintain both a TX and RX sequence number and these two sequence numbers are independent of each other. For outgoing data packages (except acknowledgement messages) each module must increase the sequence number each time a data package is sent. For incoming data packages each module checks the used sequence number and makes sure that it is increased by one. If this is not the case, then the sequence number error bit (the first bit) must be set in the acknowledgement message returned to the transmitting module.

The second segment 12b further comprises a fill byte 22 used for making sure that all data packages sent over the port connector contain an even amount of bytes. This is particularly required in case a 16 bit parity calculation is used.

The second segment 12b finally comprises a first and second parity byte 24, 26 for storing 16 parity calculated on all 16 bit words in the data package excluding the parity field. When a module receives a data package it must calculate parity of the data package and compare this calculated parity with the contents of the first and second parity bytes 24, 26, and if the calculated parity is not equal to the contents of the first and second parity bytes 24, 26, then the data package is to be discarded without sending an acknowledgement message.

It should at this point be noted that the definition “applied” in the present description is a message, which may be configured as one or more data packages, where each data package comprise a data frame (physical layer) specifying low level communication rules, i.e. when to transmit information regarding who is the intended receiver of the data package and when to transmit actual data segments. The data segments may according to the preferred embodiment of the present invention further comprise a header section, a data payload section and a termination section. Nevertheless, generally the overall structure of a data package as such is thus a header section (including physical layer data and higher layer data), a payload section and a termination section, however, in this context when referring to a header section, the header section of the data segment is meant unless specifically stated otherwise.

The preferred embodiment of the data package according to the present invention, shown in FIG. 1b, utilises the data frame 10, shown in FIG. 1a, as a physical layer in a reference model. Thus the further layers relating to the present invention are incorporated into this data frame 10 by structuring the data in a data segment 28. The data segment 28 carries the communication between modules, such as mobile communication devices and peripherals, by packaging the data to be transferred in a format shown in table 1 below.

TABLE 1
Header used on data payload to transmitted
through a port connection

| Size in bytes | Name | Comment |
|---|---|---|
| 1 | PROTOCOL | Payload type. |
| 1 | VERSION | Data Link Protocol version. |
| 2 | LENGTH | Length of the whole data packet |
| 1 | DEVICE | Sender's device number. |
| 1 | OFFSET | Payload start address |
| N1 | extensions | For extensions |
| . . . | DATA | Payload, as defined in “PROTOCOL” |
| N2 | Checksum | Calculated checksum |

In case the data amount of a message exceeds the data frame limit further information is incorporated into the header section.

As shown below in table 2 and in FIG. 1b, in case splitting a message is required, the header is further incorporated with a data package number and a data fragment number so as to enable the receiving module to identify the correct order, in which the message is to be reassembled.

TABLE 2
Header used on data payload to transmitted
through a port connection

| Size in | | |
|---|---|---|
| bytes | Name | Comment |
| 1 | PROTOCOL | Payload type. |
| 1 | VERSION | Data Link Protocol version. |
| 2 | LENGTH | Length of the whole data packet |
| 1 | DEVICE | Sender's device number. |
| 1 | OFFSET | Payload start address |
| 2 | PACKET_NO | For message splitting. |
| 2 | FRAGMENT_NO | For message splitting. |
| N1 | extensions | For extensions. |
| . . . | DATA | Payload, as defined in “PROTOCOL”. |
| N2 | Checksum | Calculated checksum |

PROTOCOL 28a

This field describes which protocol is used for a message to be communicated through a port connection, such as a communication port as in Nokia 3510. That is, the format of the DATA field. Three protocols are at present defined: NEG for negotiation protocol for data link layer protocol settings and OBEX for OBEX-type messaging. Additionally, TCP/IP, HTTP, and/or any product proprietary protocols may be coded.

VERSION 28b

This field describes the version of the header section. It should be noted that this is not the version of the protocol used for the data packages. The version is transmitted in XXX.YYY format, where XXX is the major version (binary incompatibility) and YYY is the minor version (changes which is binary compatible). For example, if the first octet of VERSION is “0”, the following conditions apply initially: transmission speed is 100 kbps, mode is single master, and the checksum is calculated from the least significant byte of the sum of all previous byte-fields from PROTOCOL and onwards. If the second octet of VERSION is different from “0”, the above mentioned conditions still apply.

LENGTH 28c

This field contains the length of the whole data package.

DEVICE 28d

This field comprises the logical device address of the module which is sending the data package. This field is necessary when sending data packages through the port connection, since the physical layer does not carry this information. The logical device address for an enhancement module is given to said module during a negotiation sequence. The mapping between logical and physical device addresses are handled in the data link layer.

OFFSET 28e

This field contains an offset in bytes of where the payload data starts in the data package. Alternatively, the offset field comprises an address for the payload data start in the data package. This field is incorporated in the header section to make the header backward compatible. When future fields are added to the header, any software can forward payload data even though the software is aware of the additional fields, since the software may forward the data package based on the OFFSET and the VERSION field.

PACKET_NO 28f

For transport protocol messages that have been split up into several data link protocol messages, this field determines, to which transport protocol message the data link fragment belongs.

FRAGMENT_NO 28g

For transport protocol messages that have been split up into several data link protocol messages, this field determines the sequence number of the fragment.

For Extensions 28h

This field is intended for compensating for future extensions of the header section. There might be a need in the future for additional fields in the header. These extensions can be added while still being backward compatible, the OFFSET field will tell the receiving module where the actual data package starts.

DATA 28i

This field contains the actual payload. This could e.g. be a proprietary message such as a Symbian or ISA type message, a non-proprietary message such as an OBEX message, an IP package or any other package format.

Checksum 28j

The checksum is calculated as a the least significant byte of the sum of all previous byte fields in the data segment 28, from PROTOCOL field and onwards.

### EXAMPLE

The present invention is below described by way of example, in which a mobile communication device communicates with a wired peripheral through a port connection and utilising the data link layer structure as described above.

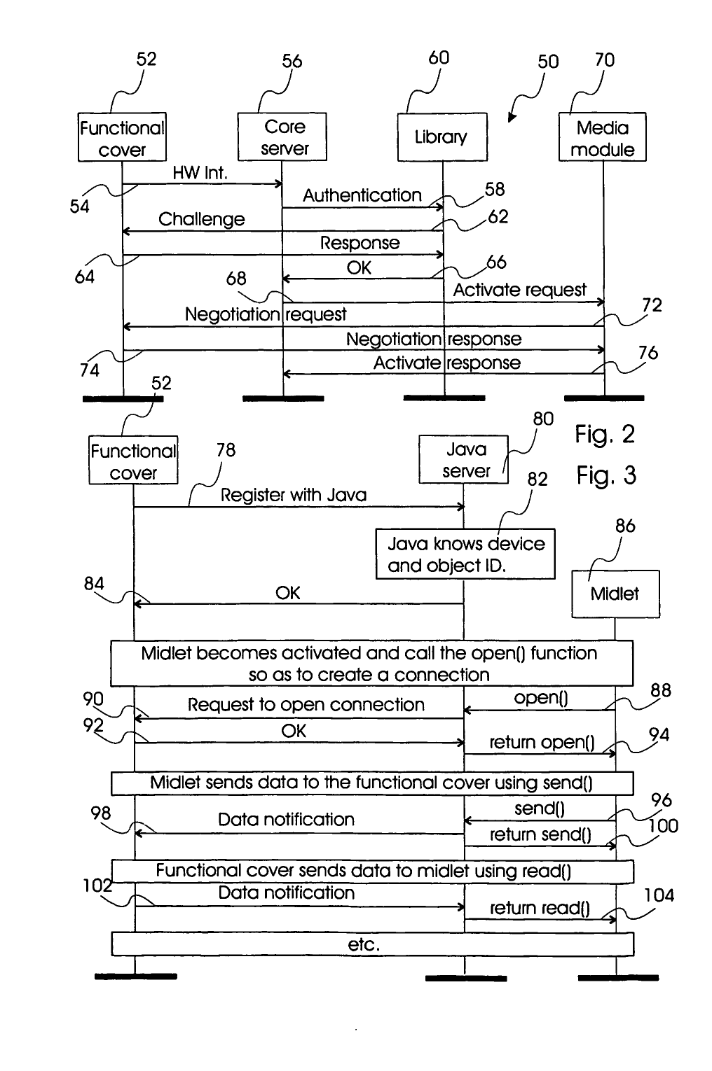

FIG. 2, shows data link layer establishing communication for a functional cover 52 and a mobile communication device, which communication is designated in entirety by reference number 50.

The functional cover 52 is a component that complies to the operating system of the mobile communication device, however, it is not designed or maintained by the operating system.

The functional cover 52 controls the start-up and shut-down of the functional cover's 52 functionality, it provides information to a java server about location of information etc. depending on the actual application implemented. The Java server provides means for starting from the applications menu midlets, which are standardized Java code modules that run in a mobile communication device. In addition, the Java server provides means for performing notification of registration of a functional cover to be contacted when a connection is required, and means for storing connection identification such as device identification (devID) and object identification (objID) to be used in conjunction with managing the connection.

A midlet may for example be a global positioning system (GPS) midlet showing a user GPS. It should be noted that the GPS midlet is not part of the operating system software of the mobile communication device.

The GPS midlet is “the brain” of a GPS functional cover feature. After the connection has been set up (i.e. all layers below the application layer are ready), the midlet is the only entity in the mobile communication device that makes decisions and controls what should happen.

The GPS midlet is stored in the mobile communication device's file system similarly to a midlet downloaded from over-the-air (OTA) facilities or uploaded using PC Suite.

When the functional cover 52 is connected to a mobile communication device a hardware interrupt is registered in a core server 56, due to the functional cover 52 causing 54 an interrupt signal.

The core server 56 handles low-level functional cover specific issues such as attachment interrupt, power-up, connector glitches, mobile communication device sleep, functional cover sleep, and reset handling.

The core server 56 requests 58 authentication of the functional cover 52 from a library 60, which, subsequently, challenges 62 the functional cover 52. If the challenge 62 is responded 64 appropriately the library 60 forwards 66 an OK-signal to core server 56, after which the core server requests 68 activation from a media module 70.

The media module 70 is able to determine which module is connected through the port connection to the mobile communication device, upon request from the core server 56. The media module 70, further implements the data link layer protocol and handles the port connection.

The media module 70 negotiates with the functional cover 52 through communicating of a negotiation request 72 and receiving a negotiation response 74. Finally, the media module 70 forwards 76 a activation response to the core server 56.

FIG. 3, shows an application layer communication, first connection establishment, and then two examples of communication.

Immediately following the establishment of the data link layer, as described with reference to FIG. 2, the functional cover 52 forwards 78 a registration signal comprising device identification and object identification to a Java server 80.

The Java server 80 registers the device and object identification during step 82 and forwards 84 an OK-signal to the functional cover 52.

At some point a midlet 86 is activated in the mobile communication device and the midlet 86 requests 88 an open( )-function of the Java server 80. The Java server 80 requests the functional cover 52 to open a connection by forwarding 90 a request signal. When the functional cover 52 provides 92 an OK-signal to the Java server 80, the Java server 80 returns 94 the open( )-function to the midlet 86.

Now the midlet 86 may transmit data to the functional cover 52, by requesting 96 utilisation of a send( )-function from the Java server, which forwards 98 a data notification comprising a message to the functional cover 52 and returns 100 the results of send( )-function to the midlet 86.

The functional cover 52 may send data to the midlet 86, which uses a read( )-function of the Java server 82 to receive the data. The functional cover 52 forwards 102 a data notification to the Java server 80, which data notification is read 104 by the midlet 86. This process may carry on for any number of cycles until all data required has been fully exchanged between the midlet 86 and the functional cover 52.

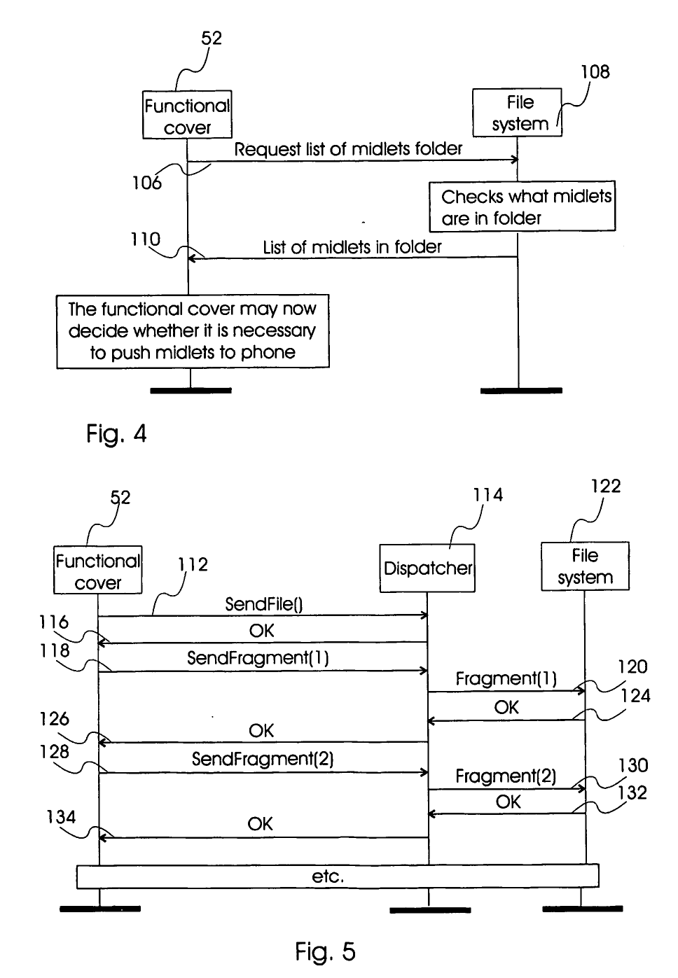

FIG. 4, shows how the functional cover 52 checks which midlets are installed on the mobile communication device. The functional cover 52 requests 106 a file system 108 for a list of midlets in a particular folder. The file system 108, subsequently, checks what midlets are in the particular folder and forwards 110 a list of midlets to the functional cover 52. The functional cover 52 may now decide whether it is necessary to push midlets to the mobile communication device.

FIG. 5, shows transmission of a midlet from the functional cover 52 to a mobile communication device. The functional cover 52 forwards 115 a midlet to a dispatcher 114 by utilising a SendFile( )-function comprising information of mimetype and filename. The dispatcher 114 forwards 116 OK-signal to the functional cover 52 upon receipt of the SendFile instruction, where after the functional cover 52 initiates transmission of a file, which in the example shown in FIG. 5, comprises more than one fragment. The data package size determines when to utilise fragmentation procedures.

The functional cover 52 utilises 118 a SendFragment( )-function for forwarding the first fragment of the file, which fragment is forwarded 120 further by the dispatcher 114 to the file system 122. The file system 122 forwards 124 a first OK-signal to the dispatcher 114 upon safe receipt of the first fragment. Subsequently, the dispatcher 114 forwards 126 a first OK-signal to the functional cover 52, which upon receipt forwards 128 a second fragment of the file to the dispatcher 114. Similarly, the dispatcher 114 forwards 130 the second fragment to the file system 122. The file system 122 forwards 132 a second OK-signal to the dispatcher 114 upon safe receipt of the second fragment. Subsequently, the dispatcher 114 forwards a second OK-signal 134 to the functional cover 52.

Obviously, this process may continue in accordance with the size of the file to be transferred between modules.

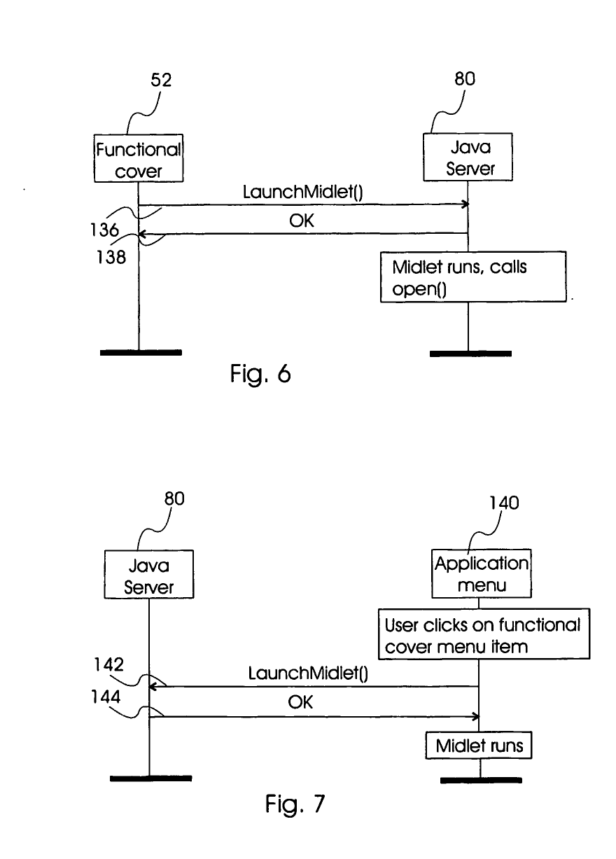

FIG. 6, shows how the functional cover 52 starts a midlet without any user interaction. The functional cover 52 utilises 136 a function call, LaunchMidlet( ), of the Java server 80, which forwards 138 an OK-signal and executes the midlet by utilising the open( )-function.

FIG. 7, shows how a user starts a midlet from an application menu 140. A user clicks on a functional cover menu item and the application menu 140 utilises 142 a LaunchMidlet( )-function call of the Java server 80. The Java server 80 forwards 144 an OK-signal to the application menu 140, which, subsequently, executes the midlet.

1. A system for providing data communication between modules connected through a port connector, wherein said modules are adapted to communicate a data package comprising in a layered structure a physical layer comprising a first and a second segment for encapsulating other layers in said data package, a data link layer comprising a first header field for data payload type and a second header field for a data link layer version, and a network/transport layer comprising a third header field for a transmitting module's address, a fourth header field for a length of said data package, and comprising data payload.

2. A system according to claim 1, wherein said modules comprise a mobile communication device such as a cell, mobile or satellite telephone, a personal digital assistant, or a peripheral thereto.

3. A system according to claim 1, wherein said data link layer version comprises a major version, which is binary incompatible, and a minor version, which is binary compatible.

4. A system according to claim 1, wherein said data package further comprises in said network/transport layer a fifth header field for an offset value for determination of data payload start in said data package.

5. A system according to claim 1, wherein said data package further comprises in said network/transport layer a sixth header field prior to said data payload start in said data package for buffering.

6. A system according to claim 1, wherein said data package further comprises a checksum field following the data payload.

7. A system according to claim 1, wherein said data package further comprises in said network/transport layer a seventh header field for a data package number.

8. A system according to claim 1, wherein said data package further comprises in said network/transport layer an eighth header field for a data package fragment sequence number.

9. A system according to claim 1, wherein said first segment of said physical layer comprises a media field for defining media across which the data package is transferred.

10. A system according to claim 1, wherein said first segment further comprises a synchronization field for synchronizing the receiving module with the transmitting module.

11. A system according to claim 1, wherein said second segment of the physical layer comprises an index byte for providing the receiving module with information regarding segmentation or partitioning of data contained in a message.

12. A system according to claim 1, wherein said second segment further comprises a sequence and acknowledge field for providing a receiving module with information whether said data package is an acknowledgement message or an ordinary message.

13. A system according to claim 1, wherein said second segment further comprises a sequence and acknowledge field is adapted to inform whether an error was identified in the received data package, when said data package is an acknowledgement message.

14. A system according to claim 12, wherein said sequence and acknowledgement field is further adapted to inform a receiving module that a sequence number in said receiving module should be reset.

15. A system according to claim 12, wherein said sequence and acknowledgement field is adapted to recognise acknowledgement messages and detect missing data packages.

16. A system according to claim 1, wherein said second segment further comprises a fill field for ensuring that all data packages sent over said port connector contain an even amount of bytes.

17. A system according to claim 1, wherein said second segment further comprises a parity field for storing parity calculated on the basis of the data package excluding the parity field.

18. A data package for communicating between modules connected through a port connection, wherein said data package comprising in a layered structure physical layer data comprising a first and a second segment for encapsulating other layers in said data package, data link layer data in a first header field comprising data payload type and in a second header field comprising a data link layer version, and network/transport layer data in a third header field comprising a transmitting module's address, in a fourth header field comprising a length of said data package, and comprising data payload.

19. A data package according to claim 18 further comprising in said network/transport layer a fifth header field for an offset value for determination of data payload start in said data package.

20. A data package according to claim 18 further comprising in said network/transport layer a sixth header field prior to said data payload start in said data package for buffering.

21. A data package according to claim 18 further comprising a checksum field following the data payload.

22. A data package according to claim 18 further comprising in said network/transport layer a seventh header field for a data package number.

23. A data package according to claim 18 further comprising in said network/transport layer an eighth header field for a data package fragment sequence number.

24. A receiver unit adapted to receive a data package according to claim 18.

25. A transmitter unit adapted to transmit a data package according to claim 18.

26. A method for establishing data communication between modules connected through a port connection, wherein said modules each communicate a data package comprising in a layered structure a physical layer comprising a first and a second segment for encapsulating other layers in said data package, and wherein said method comprising: providing in said data package in a data link layer a first header field for data payload type and a second header field for a data link layer version, providing in said data package in a network/transport layer a third header field for a transmitting module's address and a fourth header field for a length of said data package, and providing in said data package a data payload.

27. A computer program comprising code adapted to perform the following steps when said program is run in a data processor adapted to establish data communication between modules connected through a port connection, wherein said plurality of modules each communicate a data package comprising in a layered structure having a physical layer comprising a first and a second segment for encapsulating other layers in said data package, and wherein said program providing in said data package in a data link layer a first header field for data payload type and a second header field for a data link layer version, providing in said data package in a network/transport layer a third header field for a transmitting module's address and a fourth header field for a length of said data package, and providing in said data package a data payload.
